(19) United States
(12) Patent Application Publication
(10) Pub. No.: US 2009/0217383 A1
(43) Pub. Date: Aug. 27, 2009

(54) LOW-COST SECURITY USING WELL-DEFINED MESSAGES

(75) Inventors: Douglas A. Walter, Redmond, WA (US); Christopher G. Kaler, Sammamish, WA (US); John P. Shewchuk, Redmond, WA (US); Arun K. Nanda, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/037,806

(22) Filed: Feb. 26, 2008

(51) Int. Cl. G06F 21/22; H04L 9/32

(52) U.S. Cl. 726/26; 713/180

(57) ABSTRACT

Well-defined messages may be transmitted from a sending device to a recipient device in order to reduce the processing and resource requirements imposed by the security semantics of general message standards. The well-defined messages may include an expression of a collective intent of the security semantics included in the message. The expression of the security semantics within the message simplifies the discovery process for devices processing the message. The well-defined message may also require that any intermediary devices that process the well-defined message as it is transmitted from the sender device to the receiver device follow the expressed collective intent of the security semantics. If an intermediary device cannot understand or adhere to the expressed intent, the well-defined message must be rejected.

### BACKGROUND

Standard methods of providing security to messages transmitted between devices tend to be particularly taxing upon the processing and memory resources of devices. In many instances, this fact is attributed to the verbosity and rich functionality of many message standards. Due to the richness of functionality, a device receiving a message must be prepared to handle all of the functionality provided by the message standard, even though only a limited subset of the functionality is actually present in the message. Additionally, the richness of current message standards allows for many different types of digital signature blocks. This often results in large wire representations due to the multitude of scenarios, extensibility options, and canonicalization options that current message standards attempt to address. Due to the processing and resource costs presented by such factors, many devices are not able to, or choose not to, deal with the complexities of the security policies of current message standards. It is with respect to this general environment that embodiments of the present disclosure have been contemplated.

### SUMMARY

Embodiments of the present disclosure relate to systems and methods for generating and transmitting well-defined messages between a sending device and a recipient device. A well-define message is a message that clearly expresses a collective intent of security semantics. In doing so, the message may clearly express security and/or processing information related to the message such as: authentication information, the protocol information, algorithm suites, signatures, encryption, session information, and/or information about message canonicalization. The expressed intent of a well-defined message reduces the processing and memory requirements needed by devices to interpret the well-defined message by reducing the receiving device's burden to analyze the message in order to determine such information. The expressed intent further relieves the device of the burden of being prepared for multiple algorithm, signature, and canonicalization requirements present in other message standards while still providing security benefits.

Additional embodiments of the present disclosure provide for maintaining the integrity of a well-defined message while the message is en route to a recipient device. In embodiments, message elements or headers may be utilized to enforce the expressed collective intent of security semantics for the message. In embodiments, any intermediary that receives and or processes the well-defined message en route to a recipient must understand and adhere to the expressed collective intent of the well-defined message; otherwise the message is rejected by the intermediary or the recipient.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Embodiments of the present disclosure may be more readily described by reference to the accompanying drawings in which like numbers refer to like items and in which:

FIG. 1 is a flow chart representing an embodiment of a method 100 for generating by a sending device a message that expresses a collective intent of security semantics.

FIG. 2 is a flow chart representing an embodiment of a method 200 for expressing a collective intent of security semantics.

FIG. 3 is a flow chart representing an embodiment of a method 300 for processing by an intermediary device a message that expresses a collective intent of security semantics.

FIG. 4 is a flow chart representing an embodiment of a method 400 for accepting by a receiving device a message that expresses a collective intent of security semantics.

FIG. 5 is a functional diagram illustrating an embodiment of a system 500 for transmitting a message that expresses a collective intent of security semantics from a sender device to a recipient device.

FIG. 6 is a functional diagram illustrating a computer environment and computer system 600 operable to execute embodiments of the present disclosure.

### DETAILED DESCRIPTION

This disclosure will now more fully describe exemplary embodiments with reference to the accompanying drawings, in which some of the possible embodiments are shown. Other aspects, however, may be embodied in many different forms and the inclusion of specific embodiments in the disclosure should not be construed as limiting such aspects to the embodiments set forth herein. Rather, the embodiments depicted in the drawings are included to provide a disclosure that is thorough and complete and which fully conveys the intended scope to those skilled in the art. When referring to the figures, like structures and elements shown throughout are indicated with like reference numerals.

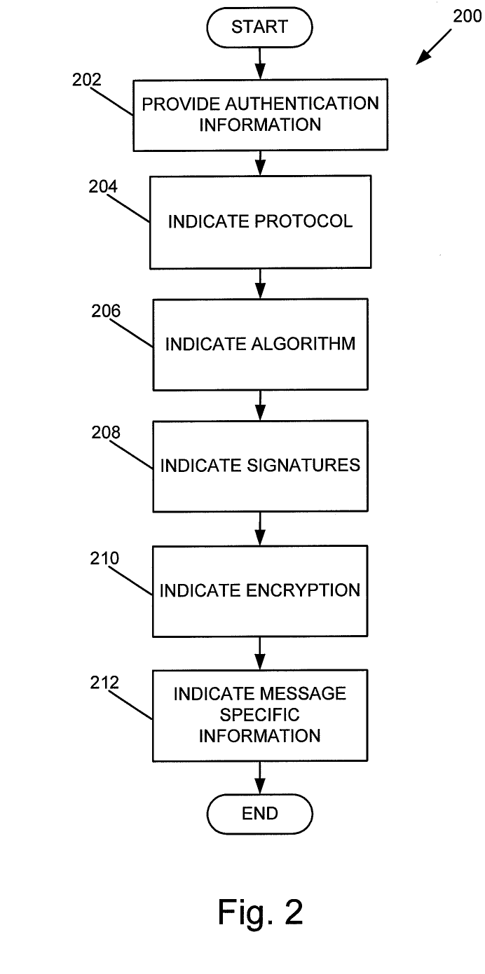

Embodiments of the present disclosure relate to systems and methods for transmitting well-defined messages between a sending device and a receiving device. In embodiments, a well-defined message is a message that is associated with an expression of a collective intent of a self-contained block security semantics that are or have been applied to the message. In one embodiment, a collective intent of a self contained block of security semantics may be a combined effect of all of the different types of security (e.g., encryption, protocols, etc.) applied to the well-defined message. In another embodiment, the collective intent of security semantics may be a grouping or a listing of all of the different types of security (e.g., encryption, protocols, etc.) applied to the well-defined message. In embodiments, a self contained block may be the portion of the message upon which the security semantics are applied. For example, the expressed security semantics may be included within a header or a signature, such as an enveloped signature discussed further with respect to FIG. 2. In such embodiments, the header or signature are applied to a portion of the message. The portion of the message enclosed by the header or signature is a self-contained block upon which the security semantics apply. In other embodiments, the self-contained block may be an entire message. One of skill in the art will appreciate that the self-contained block is any portion of a message, including the entire message, that is subject to security semantics. The well-defined message may express security or processing information related to the message such as: authentication information, the protocol information, algorithm suites, signatures, encryption, session information, and/or information about message canonicalization. In other embodiments, other message processing information may be expressed within the message. The clear expression processing information within the message, especially processing information related to message security, allows for reduced message size as well as reduced processing requirements. On the other hand, devices that receive messages that do not clearly express such processing information are required to analyze the message in order to determine the processing information. For example, the Extensible Markup Language (“XML”) is a verbose standard that is rich in functionality. Devices processing XML messages must be able to process all of the functionality of XML, including all of the canonicalization possibilities, in order to process XML messages and communicate using the standard. This generally imposes significant processing and memory requirements upon the device. However, clearly expressing the type of processing information within the message allows for smaller devices (e.g., Personal Digital Assistance (“PDAs”), Universal Serial Bus (“USB”) devices, smart phones, cell phones, etc.), which generally possess less processing power and memory than standard computing devices, to easily receive and process messages. In embodiments, a manifest element may be introduced to the message to describe message processing information and thereby simplifying security discovery and processing semantics.

In further embodiments, systems and methods disclosed herein provide for maintaining the integrity of well-defined messages en route from a sending device to a recipient device. If the message is directly transmitted from a sending device to a receiving device (e.g., without the use of intermediary devices or via a direct connection) the message integrity may be maintained during transmission. However, messages transmitted over a network, such as the Internet, generally pass through one or more intermediary devices while en route to a recipient device. Current message standards allow for intermediary devices to add information to the message while in transit. For example, an intermediary device may add a signature to the message to indicate that the message was handled by the intermediary device. The addition of such information may, at best, increase the resource requirements (e.g., processing power, amount of memory, etc.) associated with processing the message upon receipt by the recipient device and, at worst, fail to adhere to the security semantics of the well-defined message. Embodiments of the present disclosure provide for specialized statements within the message that must be adhered to by all devices that process the message. In embodiments, these specialized statements may take the form of elements and/or headers within the message. For example, a Next-hop Security Header may be included in the message that provides instructions for intermediaries that process the message.

Table 1 provides a sample well-defined message that may be used with embodiments of the present disclosure. While the example message of Table 1 is an XML message, one of skill in the art will appreciate that other types of messages, such as Hypertext Markup Language (“HTML”) messages, Extensible Hypertext Markup Language (“XHTML) messages, Simple Object Access Protocol (“SOAP”) messages, etc., may be employed with embodiments of the present disclosure. Additionally, the well-defined messages used in embodiments of the present disclosure may conform to Web Services Security (“WS-Security”) protocol or any other type of security, transport, or message protocols known to the art. Elements of the sample message will be referred to throughout this disclosure.

TABLE 1
Example Well-Defined Message

```
<?xml version=“1.0” encoding=“utf-8”?>
<S:Envelope
    xmlns:S=“http://www.w3.org/2003/05/soap-envelope”
    xmlns:A=“http://www.w3.org/2005/08/addressing”
    xmlns:U=“http://docs.oasis-open.org/wss/2004/01/oasis-200401-
wss-wssecurity-utility-1.0.xsd”
    xmlns:E=“http://docs.oasis-open.org/wss/2004/01/oasis-200401-
wss-wssecurity-secext-1.0.xsd”
    xmlns:C=“http://schemas.microsoft.com/2006/02/sxs”
  >
  <S:Header>
    <C:NextHopSecurity S:mustUnderstand=“1” S:Actor=“.../Next”>
      <C:EolCanonicalizationInUse />
    </C:NextHopSecurity>
    <A:To U:Id=“_1” S:mustUnderstand=“1”>
      http://example.org/
    </A:To>
    <A:MessageID U:Id=“_2”>_123456789</A:MessageID>
    <E:Security S:mustUnderstand=“1”>
      <U:Timestamp U:Id=“_3”>
        <U:Created>2006-02-02T19:59:47.329Z</U:Created>
        <U:Expires>2006-02-02T19:59:47.329Z</U:Expires>
      </U:Timestamp>
      <E:SecurityTokenReference U:Id=“_4”>
        ...
      </E:SecurityTokenReference>
      <C:Sig
          U:Id=“_5”
          Alg=“http://schemas.microsoft.com/2006/02/sxs/suites/
          Basic256Eol”
          Key=“_4”
          AEL=“3”
          SEL=“_3”
          PEL=“_1 _2”
          Bod=“1”>
        <C:SigVal>mLPyJkI4e2wdezjYRUOGVjFsEp4=</C:SigVal>
      </C:Sig>
    </E:Security>
  </S:Header>
  <S:Body>
    <X:ApplicationStuff />
  </S:Body>
</S:Envelope>
```

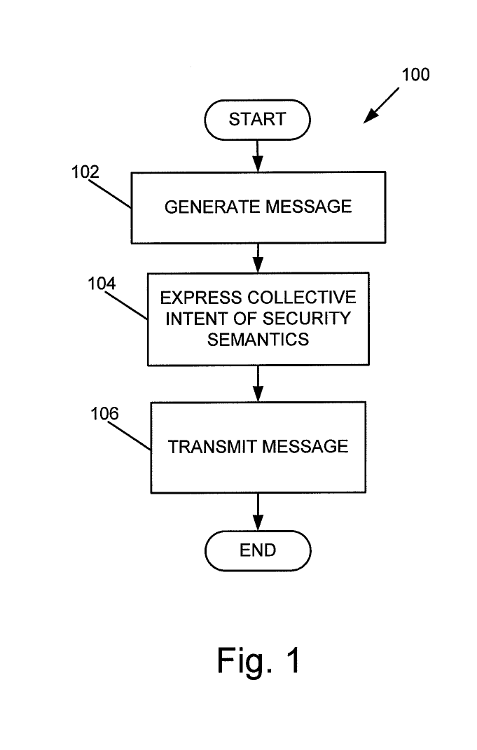

FIG. 1 is a flow chart representing an embodiment of a method 100 for generating a message that expresses a collective intent of security semantics. In embodiments, the well-defined message may be generated by a sending device. In other embodiments, a sending device may generate a message which later becomes a well-defined message through modification by an intermediary device. Flow begins at step 102 where a sending device generates a message. The message generated at step 102 may be an XML message, such as the example message of Table 1, a HTML message, a XHTML message, a SOAP message, or any other type of message known to the art. In embodiments, the message generated conveys information and/or instructions from the sending device intended for a recipient device. In embodiments, the message generated at step 102 is a well-defined message as described in embodiments of the present disclosure. In other embodiments, the message generated at step 102 is not a well-defined message.

Flow proceeds to step 104 where the collective intent of the security semantics of the message is expressed within the message. In embodiments, security semantics of the message may be clearly expressed by including security or processing information related to the message such as: authentication information, the protocol information, algorithm suites, signatures, encryption, session information, and/or information about message canonicalization. In other embodiments, other message processing information may be expressed within the message. Additionally, the message may identify additional characteristics of the message relevant to security processing and/or message canonicalization.

In one, non-limiting embodiment, a manifest (e.g., <C:Manifest>) may be used to identify high-level characteristics of various security actions, message processing information, or meta-data relevant to a security processor. For example, the <C:Manifest> element may include information such as: a Universal Resource Identifier (“URI”) identifying that a certain protocol is being used with the message, information regarding the use of keys with the message as well as the purpose of the keys, information related to the algorithm suite being used (e.g., a default algorithm suite or other algorithm suite), the time the manifest was created, or any other type of information relevant to the security and/or processing of the message. In embodiments, the <C:Manifest> element may provide additional meta-data to security processors. In such embodiments, the meta-data contained within the <C:Manifest> element may be used to guide the processing approach of a recipient device when processing security information associated with the message. Table 2 provides and example schema of a <C:Manifest> element that may be used with embodiments of the present disclosure. Attributes of the <C:Manifest> element will be further explained with respect to FIG. 2.

TABLE 2
Example Schema of a <C:Manifest> Element

```
<C:Manifest
  U:Id=“xs:ID”
  Pro=“xs:anyURI”?
  SID=“xs:anyURI”?
  Alg=“xs:anyURI”?
  SK=“xs:ID List”?
  CSK=“xs:ID List”?
  EK=“xs:ID List”?
  ... >
  <U:Created>xs:DateTime”</U:Created>?
  <U:Expires>xs:DateTime”<U:Expires>?
  ...
</C:Manifest>
/C:Manifest
      A message security manifest element.
/C:Manifest/@U:Id
      A required identifier for the manifest.
/C:Manifest/@Pro
      An optional URI identifying the protocol being used. If absent, this value must
      be known and agreed to by both parties using mechanisms outside the scope of
      this document.
/C:Manifest/@SID
      An optional attribute containing a “URI” identifying a security session being
      used.
/C:Manifest/@Alg
      An optional URI identifying the algorithm suite to use for performing
      signatures and encryptions. If present, this value may be used to populate the
      value for specific signatures and encryptions if unspecified on those elements.
/C:Manifest/@SK
      An optional attribute containing a list of “ID” references to elements which
      contain a token or references to a token which were used to sign the message.
/C:Manifest/@CSK
      An optional attribute containing a list of “ID” references to elements which
      contain a token or references to a token which were used to co-sign the
      message.
/C:Manifest/@EK
      An optional attribute containing a list of “ID” references to elements which
      contain a token or references to a token which were used to encrypt the
      message.
/C:Manifest/@{any}
      This is an extensibility point to allow additional attributes.
/C:Manifest/U:Created
      An optional sub-element containing a value indicating the date and time the
      manifest was created. The WS-Security element is re-used but is placed inside
      the manifest to simplify processing.
/C:Manifest/U:Expires
      An optional sub-element containing a value indicating the date and time the
      manifest should expire. The WS-Security element is re-used but is placed
      inside the manifest to simplify processing.
/C:Manifest/{any}
      This is an extensibility point to allow additional elements to be included in the
      manifest. These elements are included in any signature that includes the
      manifest. Any sub-elements must not alter the processing semantics from the
      behavior specified in this document.
```

In embodiments, the <C:Manifest> element may appear as a header within a well-defined message or, alternatively, within a header contained in the well-defined message. For example, in embodiments where the message complies with the WS-Security protocol, the <C:Manifest> element may be included within the <E:Security> header in order to simplify security discovery and processing semantics. One of skill in the art will appreciate that a <C:Manifest> element may be included in different portions of a message while still identifying message processing and message security information. Those skilled in the art will also appreciate that although step 102 has been described with respect to the use of a <C:Manifest> element, the element has been provided solely for ease of description. Other elements or other means of identifying message processing and message security information known to the art may be employed with embodiments of the present disclosure.

In further embodiments, information regarding message canonicalization (the process of converting data that has more than one possible representation into a standard representation) may also be expressed within the message at step 102. In embodiments, information describing the canonicalization algorithm used with the message generated at step 102 may be included within the message at step 104. In embodiments, the specific canonicalization algorithm may be enforced as the message is transmitted from a sender device to a recipient device. For example, any intermediary device that processes the message en route to the recipient device may be bound to use the canonicalization algorithm defined within the message (e.g., the intermediary device cannot modify and/or add data to the message that would change the canonicalization of the message). In such embodiments, defining the canonicalization algorithm provides for a straight-forward canonicalization transform, thereby reducing processing and memory costs associated with the signature generation and validation of the message. This allows for low-powered devices such as PDAs, USB devices, smart phones, and cell phones to process the message.

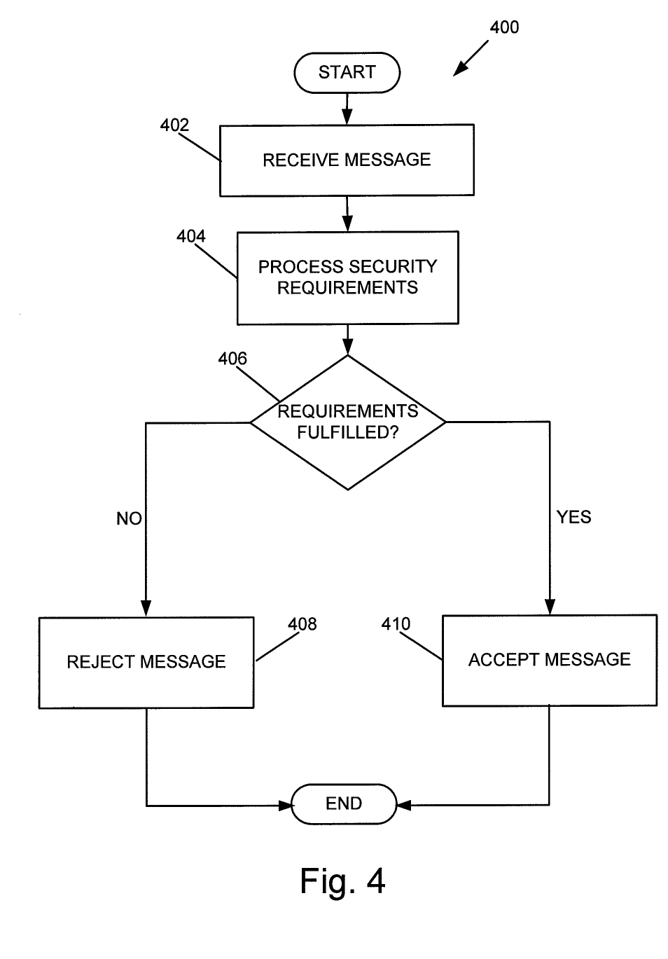

In embodiments, a Next-hop Security Header element (see, e.g., Table 1) may be used to provide instructions for intermediary devices that process the well-defined message as it is transmitted from the sender device to the recipient device. In embodiments, the Next-hop Security Header may preserve and carry forward any serialization and/or processing assumptions used by the sending device that encoded the message. This may include aspects such as the use of canonicalization and enveloped signatures, which is discussed further below with respect to FIG. 2. In embodiments, the Next-hop Security Header may be used to provide a straight-forward canonicalization transform. This allows for the avoidance of costly canonicalization and signature validation that is typical in mark-up languages, such as XML, that allow for many different forms of canonicalization. By providing a straight-forward canonicalization, devices processing the well-defined message are relieved from having to process many different canonicalization transforms. In further embodiments, the Next-hop Security Header may indicate that an intermediary device, through which the well-defined message may pass en rout to a recipient, must understand and adhere to the assumptions indicated by the Next-hop Security Header; otherwise, the intermediary device must reject the message, which is discussed further with respect to FIG. 4. In further embodiments, the Next-hop Security Header may be a container header element that may contain various security processing instructions for the message (e.g., a canonicalization element to declare the type of canonicalization that is in use with the message, an enveloped signature element to declare that an enveloped signature is in use, etc.). The requirement that intermediaries reject the message if they do not understand the instructions may also be expressed at the level of the Next-hop Security Header. While the specification describes the Next-hop Security as a message header, one of skill in the art will appreciate that the Next-hop Security may be expressed in the form of an element, an attribute, or any other portion of a message. Table 3 provides an example schema of a Next-hop Security header used with a SOAP message.

TABLE 3
Example Schema of a </C:NextHopSecurity> Element

```
<C:NextHopSecurity S:mustUnderstand=“1” S:role=“.../Next” ...>
  ...
</C:NextHopSecurity>
/C:NextHopSecurity
      This header element contains security-specific instructions for
      intermediaries.
/C:NextHopSecurity/@S:mustUnderstand
      The SOAP Must Understand attribute on this header must be
      present and must be set to “true”.
/C:NextHopSecurity/@S:role
      The SOAP Actor or Role attribute must be present and must be
      set to “Next”.
      The attribute name and the actual value of “Next” is specific
      to the version of SOAP being used.
```

While embodiments of the present disclosure have been described with respect to a Next-hop Security header, one of skill in the art will appreciate that any other type of header and/or means of expressing serialization and/or processing assumptions may be employed with embodiments of the present disclosure. One of skill in the art will appreciate that, upon expressing the collective intent of the security semantics, the message generated at step 102 becomes a well-defined message according to embodiments of the present disclosure regardless of how the collective intent is expressed.

After expressing the collective intent of security semantics within the message, flow proceeds to step 106 where the well-defined message is transmitted to the intended recipient. In embodiments, the well-defined message is transmitted directly from a sender device to a recipient device. In other embodiments, the well-defined message is transmitted from the sender device to the recipient device via one or more intermediary devices. As described with respect to step 104, the well-defined message may include information (e.g., a header such as a <C:NextHopSecurity> header (Table 1 and 3)) that preserve the assumptions used by a device in generating and/or expressing the collective intent of the well-defined message, thereby ensuring that the recipient device receives the well-defined message according to the generating device's assumptions. In further embodiments, the well-defined message may be saved into volatile or non-volatile memory of the device before being sent. In such embodiments, saving the message provides a back-up of the message in case the message is lost, corrupted, and or rejected during transmission from a sender to a recipient.

In other embodiments, step 104 may be performed simultaneously with step 102 by the sending device. For example, information related to expressing the collective intent of security semantics may be included within the message as it is generated in step 102. In other embodiments, the expression of the collective intent of security semantics may be inserted into the message by a device other than the sender. For example, an intermediary device may insert information related to the collective intent within the message. Embodiments of the present disclosure will operate regardless of which device inserted the collective intent into the message so long as the collective intent is adhered to by all devices that process the message after the intent has been expressed. In further embodiments, the collective intent may not be expressed within the message itself, but in a message or attachment accompanying the message.

FIG. 2 is a flow chart representing an embodiment of a method 200 for expressing a collective intent of security semantics. In embodiments, expressing the collective intent of security semantics comprises associating security-related information with a message. For example, the security-related information may be inserted into the message or, in alternate embodiments, may accompany the message (e.g., in another message or in an attachment). The steps of FIG. 2 provide non-limiting examples of types of information that related to security semantics that may be utilized to express the collective intent of security semantics within the message. One of skill in the art will appreciate that other types of information not described with respect to FIG. 2 may also be associated with a message when expressing a collective intent of security semantics.

Flow begins at step 202, where authentication information is provided with the message. In embodiments, authentication information may include a password, a key, or any other type of information known to the art for authenticating a message. In other embodiments, the information provided in step 202 may be used to authenticate a user, a sender device, an intermediary device, or any other device associated with the message.

Flow proceeds to step 204, where one or more indications of the protocol or protocols being used with a message are associated with the message. In embodiments, the protocols may relate to transmission protocols, message processing protocols, security protocols, or any other types of protocols known to the art.

For example, in one embodiment, the X509 protocol may be used with the message and thus indicated at step 204. The X509 protocol uses two certificates, one to identify a service and another to identify the client. In embodiments using the X509 protocol, one X509 token may be used to identify the message initiator and another token may be used to identify a message recipient. In such embodiments, the X509 protocol may be indicated by associating the protocol with the message. The protocol may be associated with the message by associating the protocol policy with the message, by associating a URI of the protocol with the message, or by any other means of associating a protocol with a message known to the art. In embodiments using the <C:Manifest> element of Table 2, a URI identifying the X509 protocol may be identified by the /C:Manifest/@Pro attribute. Table 4 provides an example policy for the X509 protocol that may be used with embodiments of the present disclosure.

TABLE 4
Example Policy for the X509 Protocol

```
<wsp:Policy>
  <sp:AsymmetricBinding>
    <wsp:Policy>
      <sp:InitiatorToken>
        <wsp:Policy>
          <sp:X509Token />
        </wsp:Policy>
      </sp:InitiatorToken>
      <sp:RecipientToken>
        <wsp:Policy>
          <sp:X509Token />
        </wsp:Policy>
      </sp:RecipientToken>
      <sp:AlgorithmSuite>
        <wsp:Policy>
          <C:Basic256Eol />
        </wsp:Policy>
      </sp:AlgorithmSuite>
      <sp:IncludeTimestamp />
      <sp:EncryptSignature />
      <sp:OnlySignEntireHeadersAndBody />
      <C:SxsSignature />
      <C:SxsEncryption />
      <C:SxsNextHopSecurity />
    </wsp:Policy>
  </sp:AsymmetricBinding>
</wsp:Policy>
```

In other embodiments, a Username Message Protocol may be indicated at step 204. The Username Message Protocol makes use of a Username token to identify a message initiator and an X509 token to identify a message recipient. In embodiments, the Username Message Protocol may be indicated by associating the protocol with the message. The protocol may be associated with the message by including the protocol policy within the message, by including a URI of the protocol with the message, or by any other means of associating a protocol with a message known to the art. In embodiments using the <C:Manifest> element of Table 2, a URI identifying the Username Message Protocol may be identified by the /C:Manifest/@Pro attribute. Table 5 provides an example policy for the Username Message Protocol that may be used with embodiments of the present disclosure.

TABLE 5
Example Policy of the Username Message Protocol

```
<wsp:Policy>
  <sp:SymmetricBinding>
    <wsp:Policy>
      <sp:ProtectionToken>
        <wsp:Policy>
          <C:X509Token />
        </wsp:Policy>
      </sp:ProtectionToken>
      <sp:AlgorithmSuite>
        <wsp:Policy>
          <C:Basic256Eol />
        </wsp:Policy>
      </sp:AlgorithmSuite>
      <sp:IncludeTimestamp />
      <sp:EncryptSignature />
      <sp:OnlySignEntireHeadersAndBody />
      <C:SxsSignature />
      <C:SxsEncryption />
    </wsp:Policy>
  </sp:SymmetricBinding>
  <sp:SignedSupportingTokens>
    <wsp:Policy>
      <sp:UsernameToken />
    </wsp:Policy>
  </sp:SignedSupportingTokens>
</wsp:Policy>
```

The specific protocols provided in Tables 4 and 5 are provided as examples of protocols that may be indicated at step 204. One of skill in the art will appreciate that any other type of protocol used in message security, processing, and/or transport may be indicated within a message while remaining within the scope of embodiments of the present disclosure.

Flow proceeds to operation 206 where algorithms used in for purposes of security, creation, and/or processing of the message are associated with the message. In embodiments, any type of algorithm used with the message may be indicated at step 206. Algorithms may be indicated by associating a representation of the algorithm with the image. In other embodiments, the algorithm may be indicated by a URI identifying the algorithm. For example, in embodiments using the <C:Manifest> element described in Table 2, an algorithm may be identified by a URI associated with the /C:Manifest/@Alg attribute of the <C:Manifest> element. One of skill in the art will appreciate that there are many ways of associating an algorithm with a message. Embodiments of the present disclosure will operate regardless of how the algorithm is associated with the message.

In another embodiment, an algorithm suite may be associated with the message. For example, an algorithm suite may be a mechanism whereby a single URI is used to represent a set of algorithms that have been selected to be used with the message. In some embodiments, while the algorithm suite may contain multiple algorithms, only a single algorithm may be defined for each specific task. In most message systems, a number of different algorithms may be associated with specific tasks. Devices that desire to use such message systems must be prepared to potentially apply multiple algorithms to each task, which takes a signification amount of processing resources. Associating a single algorithm with each specific task reduces the number of algorithms associated with each task, which in turn reduces the amount of processing necessary to process the message. For example, an algorithm suite with multiple algorithms for different tasks may contain a single digest algorithm, such as SHA-1. In such an example, the device processing the message would only have to apply SHA-1 as a digest algorithm, thus reducing the need for the device to process and/or apply other digest algorithms. However, in other embodiments, multiple algorithms may be defined for each task.

In embodiments, the algorithm or algorithm suites associated with the message may be associated by inserting assertion elements into the message. For example, if an algorithm or algorithm suite, such as a Basic256Eol algorithm suite, may be inserted into the message using a <C:Basic256Eol /> assertion element. The <C:Basic256Eol /> assertion element identifies the Basic256Eol algorithm suite. In embodiments, assertion elements, such as the <C:Basic256Eol/> assertion element, may be defined and used as an indication of an algorithm incorporated with the message instead of using a URI as an indication. In further embodiments, both assertion elements and URIs may be used to indicate algorithm(s) incorporated with the message. In embodiments, any number of assertion elements may be defined to identify different algorithms or algorithm suites. In further embodiments using WS-Security, an algorithm assertion element may appear as sub-assertion under an <sp:AlgorithmSuite> assertion.

One of skill in the art will appreciate that the preceding algorithms and algorithm suites were provided merely as examples and are not limiting. Embodiments of the present disclosure will operate regardless of the algorithms or algorithm suites indicated in step 206. Additionally, any way of identifying an algorithm may be incorporated with embodiments of the present disclosure so long as any algorithm associated with the message is clearly indicated.

Flow proceeds to step 208 where any signatures associated with the message are indicated. In embodiments, signatures may be used to define keys used with the message, indicate what devices have processed the message, to provide authentication information, to indicate the originator of a message, or for any other purpose known to the art. In embodiments, signatures may be applied to the entire message or to portions of a message. In embodiments of the present disclosure, signatures may be indicated through the use of tokens, references to tokens, or certificates. For example, in embodiments using the <C:Manifest> element of Table 2, a signature may be identified by a reference associated with the /C:Manifest/@SK or /C:Manifest/@CSK attributes associated with the <C:Manifest> element.

In other embodiments, signatures may be indicated by the use of signature elements. Any number of signature elements may be defined and incorporated into a message. In embodiments of the present disclosure that use WS-Security, signature elements may be inserted into a <E:Security> header or a <C:EmbSec> element. Many different types of signatures and signature elements may be defined for and/or incorporated into embodiments of the present disclosure. For example, a selective signature may be identified within the message. In embodiments, a selective signature may define keys used with the message, references to parts of the signature, signature values, etc. Selective signatures may also include algorithm suites, external token references, and signature values that can be encrypted directly without the use of an intermediate digest. Table 6 provides an example signature element that may be used to identify a signature or a selective signature.

TABLE 6
Example Signature Element

```
<C:Sig
  U:Id=”xs:ID”
  Alg=”xs:anyURI”?
  Key=”xs:ID”?
  Ekey=”xs:ID”?
  Dec=”xs:Boolean”?
  AEL=”xs:int”?
  SEL=”xs:ID List”?
  PEL=”xs:ID List”?
  Usg=”xs:anyURI List”?
  ... >
  <C:SigVal>xs:base64</C:SigVal>
  ...
</C:Sig>
/C:Sig
      A signature element.
/C:Sig/@U:Id
      A required identifier for the signature. All signatures have an ID so that
      subsequent co-signing is possible.
/C:Sig/@Alg
      An optional URI identifying the algorithm suite to use for computing the
      signature. If absent, this value must be known and agreed to by both parties
      using mechanisms out-of-scope of this document. A value from the table
      described in Section 2.2 may be used.
/C:Sig/@Key
      An optional ID reference to the token or token reference used to compute the
      signature.
/C:Sig/@Ekey
      An optional ID reference to the token or token reference used to encrypt the
      signature value.
/C:Sig/@Dec
      An optional attribute specifying whether to include the XML Declaration in
      the signature. This attribute has a default value of “false”.
/C:Sig/@AEL
      An optional attribute that defines the number of ancestor element declarations
      to include in the signature (in terms of levels). This attribute has no default
      value.
/C:Sig/@SEL
      An optional attribute containing a list of “ID” references of sibling elements
      relative to the signature element to include in the signature. This attribute has
      no default value.
/C:Sig/@PEL
      An optional attribute containing a list of “ID” references of sibling elements
      relative to the parent element of the signature element to include in the
      signature. This attribute has no default value.
/C:Sig/@Usg
      An optional attribute containing a list of absolute URI references indicate the
      reason the signature is included. This specification does not pre-define any
      URI values. Any values defined for the WS-Security @Usage attribute may
      be used here.
/C:Sig/@{any}
      This is an extensibility point to allow additional attributes to be specified
      (which will be signed). No attribute can be placed here which impacts the
      processing model or causes semantics to be other than described in this
      document.
/C:Sig/C:SigVal
      A required sub-element containing the base-64 encoded computed signature
      value.
/C:Sig/{any}
      This is an extensibility point to allow additional elements that need to be
      signed to be specified. No element can be placed here which impacts the
      processing model or causes semantics to be other than described in this
      document.
```

In other embodiments, co-signatures may be added to the message. In embodiments, a co-signature is a signature that is created over a primary signature. Because the primary signature provides context information, co-signatures do not have to include context information. Like signatures and selective signatures, co-signatures may also be indicated through the use of a signature element. However, in embodiments, a specific signature element may be created to indicate a co-signature. Table 7 provides an example co-signature element as well as a discussion of its attributes.

TABLE 7
Example Co-Signature Element

```
<C:CoSig
  Alg=”xs:anyURI”?
  Key=”xs:ID”?
  Ekey=”xs:ID”?
  SEL=”xs:ID List”?
  Usg=”xs:anyURI”?
  ... >
  <C:SigVal>xs:base64</C:SigVal>
  ...
</C:CoSig>
/C:CoSig
      A co-signature element.
/C:CoSig/@Alg
      An optional URI identifying the algorithm suite to use for computing the
      signature. This attribute has no default value. If absent, this value must be
      known and agreed to by both parties using mechanisms out-of-scope of this
      document. A value from the table described in Section 2.2 may be used.
/C:CoSig/@Key
      An optional ID reference to the token or token reference used to compute the
      signature.
/C:CoSig/@Ekey
      An optional ID reference to the token or token reference used to encrypt the
      signature value.
/C:CoSig/@SEL
      An optional attribute containing a list of “ID” references of sibling elements
      relative to the signature element to include in the signature. This attribute has
      no default value. This attribute should have at least one reference to a <C:Sig>
      element.
/C:CoSig/@Usg
      An optional attribute containing a list of absolute URI references indicate the
      reason the signature is included. This specification does not pre-define any
      URI values. Any values defined for the WS-Security @Usage attribute may
      be used here.
/C:CoSig/@{any}
      This is an extensibility point to allow additional attributes to be specified
      (which will be signed). No attribute can be placed here which impacts the
      processing model or causes semantics to be other than described in this
      document.
/C:CoSig/C:SigVal
      A required sub-element containing the base-64 encoded computed signature
      value.
/C:CoSig/{any}
      This is an extensibility point to allow additional elements that need to be
      signed to be specified. No element can be placed here which impacts the
      processing model or causes semantics to be other than described in this
      document.
```

In further embodiments, enveloped signatures may be added to the message. In embodiments, an enveloped signature may be used to sign an entire message (e.g., the signature is used to envelope and/or cover the entire message) beginning with any portion of the message immediately preceding the enveloped signature. For example, an enveloped signature used in a mark-up language (e.g., XML, HTML, etc.) may cover the entire message including the ancestor element at the specified level above the enveloped signature. In other embodiments, the enveloped signature may cover only a portion of the message. Like signatures and co-signatures, the enveloped signature element may be indicated within the message using a signature element. Table 8 provides an example enveloped signature element and attributes that may be used with embodiments of the present disclosure.

TABLE 8
Example Enveloped Signature Element

```
<C:EnvSig
  Alg=”xs:anyURI”? >
  Key=”xs:ID”?
  Ekey=”xs:ID”?
  Lev=”xs:int”?
  Dec=”xs:Boolean”?
  ... >
  <C:SigVal>xs:base64</C:SigVal>
  ...
  />
/C:EnvSig
      A enveloped signature element.
/C:EnvSig/@Alg
      An optional URI identifying the algorithm suite to use for computing the
      signature. If absent, this value must be known and agreed to by both parties
      using mechanisms out-of-scope of this document. A value from the table
      described in Section 2.2 may be used.
/C:EnvSig/@Key
      An optional ID reference to the token or token reference used to compute the
      signature.
/C:EnvSig/@Ekey
      An optional ID reference to the token or token reference used to encrypt the
      signature value.
/C:EnvSig/@Lev
      An optional attribute describing the number of levels up the ancestor (parent)
      axis relative this <C:EnvSig> element where the signature computation should
      begin. The enveloped signature will cover the element identified by this
      attribute and all of its contents. This attribute has no default value. If absent,
      this value must be known and agreed to by both parties using mechanisms out-
      of-scope of this document.
/C:Sig/@Dec
      An optional attribute specifying whether to include the XML Declaration in
      the signature. This attribute has a default value of “false”.
/C:EnvSig/@{any}
      This is an extensibility point to allow additional attributes to be specified
      (which will be signed). No attribute can be placed here which impacts the
      processing model or causes semantics to be other than described in this
      document.
/C:EnvSig/C:SigVal
      A required sub-element containing the base-64 encoded computed signature
      value.
/C:EnvSig/{any}
      This is an extensibility point to allow additional elements that need to be
      signed to be specified. No element can be placed here which impacts the
      processing model or causes semantics to be other than described in this
      document.
```

Enveloped signatures provide additional benefits due to the fact that they may encompass the entire message. For example, an enveloped signature may be combined with the <NextHopSecurity> element of Table 3 in order to apply the canonicalization requirements of the <NextHopSecurity> element to the entire message. In this way, the security and canonicalization intent can be maintained for the entire message.

While Tables 6-8 describe specific embodiments of signature elements used in providing indications of a signature, one of skill in the art will recognize that any other means of providing indications within a message may be employed with embodiments of step 208. Furthermore, in other embodiments, the signature elements may be used to express actual signatures rather than indications of signatures.

Flow proceeds to step 210 where an indication of the encryption used with the message is provided. In embodiments, the encryption may be indicated within the message in order to simplify processing and minimize wire size by restricting the number of options supported by common encryption techniques. In embodiments, the type of encryption used may be clearly stated within the message. For example, the message may contain an indication that the message is encrypted using AES or DES encryption. Thus, upon receiving the message, a recipient device knows what type of decryption to apply to the message without having to first process the message to determine its encryption. This allows for less intensive processing on the part of the recipient device. Furthermore, such reduction can be made without establishing a prior agreement as to the type of encryption that will be used when sending a message between a sender device and a recipient device. In embodiments, the encryption may be indicated by a plain text statement within the message. In other embodiments, a token or a reference to a token may be used to indicate the type of encryption. In other embodiments using the <C:Manifest> element, the /C:Manifest/@EK attribute may be used to indicate the encryption being used.

In other embodiments, elements may be defined and used to indicate encryption. In such embodiments, elements may be defined that specifically identify the encrypted portions of a document. Table 9 provides an example of such an encryption reference element and attributes.

TABLE 9
Example Encryption Reference Element

```
<C:EncRef
  Alg=”xs:anyURI”?
  Key=”xs:ID”?
  SEL=”xs:ID List”?
  PEL=”xs:ID List”?
  ... >
  ...
</C:EncRef>
/C:EncRef
      A encryption reference element.
/C:EncRef/@Alg
      An optional URI identifying the algorithm suite to use for
      performing encryption. If absent, this value must be known and
      agreed to by both parties using mechanisms out-of-scope of
      this document. A value from the table described in Section 2.2
      may be used.
/C:EncRef/@Key
      An optional ID reference to the token or token reference used for
      the decryption operation.
/C:EncRef/@SEL
      An optional attribute containing a list of “ID” references of sibling
      elements relative to the encryption reference element that are
      encrypted. This attribute has no default value.
/C:EncRef/@PEL
      An optional attribute containing a list of “ID” references of sibling
      elements relative to the encryption reference element's parent
      element that are encrypted. This attribute has no default value.
/C:EncRef/@{any}
      This is an extensibility point to allow additional attributes.
/C:EncRef/{any}
      This is an extensibility point to allow additional elements.
```

In other embodiments, encryption elements may also be defined to use as a replacement for encrypted content of the message. In such embodiments, these replacement elements may be inserted into the message in order to provide an indication of the type of encryption used with the message. In further embodiments, elements may also be defined to identify an encrypted key. These encrypted key elements may also serve as an indication of the encryption used with the message. While step 210 has been described according to specific embodiments, those of skill in the art will recognize that the described embodiments are for illustrative purposes only. Any method of indicating a type of encryption used with a message may be practiced with embodiments of the present disclosure.

Flow proceeds to operation 212 wherein message-specific information is indicated. In embodiments, message-specific information may be any type of information related to the message that has bearing upon security, such as: message creation time, message expiration time, message session IDs, security session IDs, etc. For example, the message creation time and message expiration time may be used to determine the validity of a message. For example, if the creation time of an expected message is known, the known creation time can be compared to the creation time of a received message in order to determine whether the received message is indeed the expected message. Such comparisons may be useful in preventing man in the middle type attacks. Additionally, the inclusion of a message expiration time may save processing and memory resources by providing that messages are discarded one the expiration time has elapsed. In embodiments using the <C:Manifest> element, the message creation time and message expiration time may be indicated in the /C:Manifest/U:Created and /C:Manifest/U:Expires attributes. Other type of information, such as security session ID information, may also be indicated in the <C:Manifest> /C:Manifest/@SID element.

While embodiments of FIG. 2 have been described with respect to specific methods for indicating various types of authentication information, protocols, algorithms, signatures, encryptions, and sessions, one of skill in the art will appreciate that the specific methods have been used solely for descriptive purposes. Embodiments of the present disclosure will operate regardless of the ways in which the various indications are made. So long as the indications are made, devices receiving and/or processing the messages save processing power and resources by avoiding the type of message analysis typically performed to discover the type of indicated information. This allows for small computing devices to receive and process different types of messages that the devices were previously unable to process due to a lack of resources.

In embodiments, the well-defined message may be processed by one or more intermediary devices before reaching the recipient device. In this sense, processing the message by an intermediary device may comprise nothing more than routing the message to another intermediary device or to a recipient device. For example, if the message is passed from a sender device to a recipient device over a network such as the Internet, the message will likely pass though a number of servers and routers en route to the recipient device. Generally, these intermediary devices have the ability to add to and/or modify a message when processing the message. For example, an intermediary device may add a signature to any message that it processes in order to keep a record of the path that the message took from the sender device to the recipient device. However, when processing a well-defined message, embodiments of the present disclosure provide that the integrity of the well-defined message is maintained. In other words, embodiments of the disclosure provide that the collective intent of the security semantics expressed in the message at step 102 (FIG. 2) be maintained.

In embodiments, the collective intent of the security semantics is adhered to by a previous agreement between devices that process the well-defined message. For example, the devices may establish a previous agreement that all expressed security intentions, for example, all the security indications expressed in a <C:Manifest> element, are adhered upon and remain unchanged. In another embodiment, adherence to the collective intent may be enforced by the well-defined message itself. For example, the well-defined message may include a <NextHopSecurity> element, as previously discussed with respect to FIG. 2, that requires all intermediary devices that process the message to adhere to the canonicalization and signature requirements expressed within the <NextHopSecurity> element or other element within the message. These requirements may be attached to the entire message by using the <NextHopSecurity> element with an enveloped signature, as discussed in step 208 (FIG. 2). Embodiments of the present disclosure also provide that once a message is well-defined, headers, elements, or content, such as the <NextHopSecurity> and <C:Manifest> elements, cannot be removed from the message. If the removal restrictions are not adhered to, the message will be subsequently rejected and discarded.

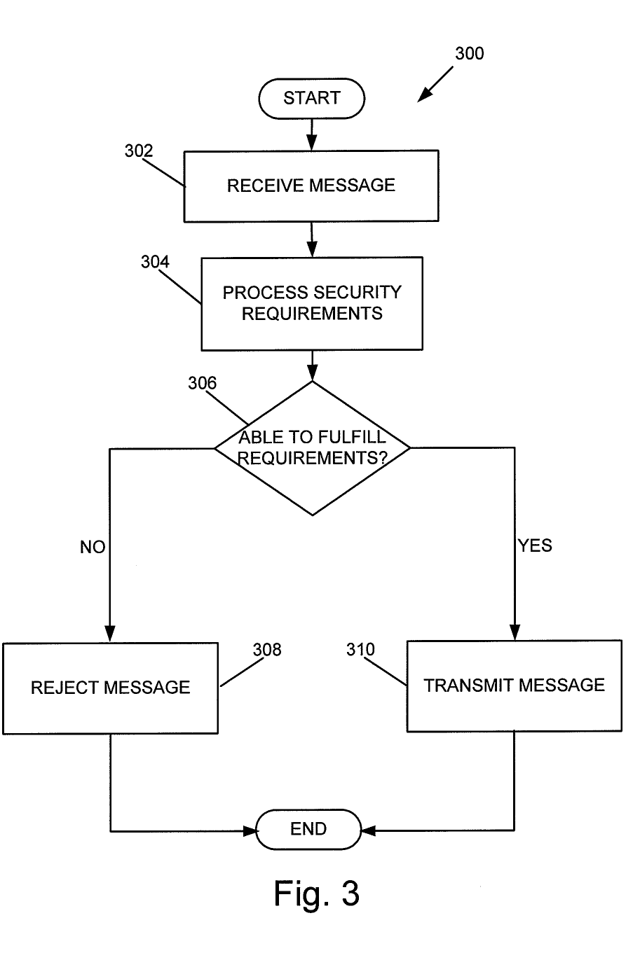

FIG. 3 is a flow chart representing an embodiment of a method 300 for processing a well-defined message that expresses a collective intent of security semantics by an intermediary device. An intermediary or intermediary device is a device in which the well-defined message passes through en rout to its intended recipient. Flow begins at step 302, where the intermediary device receives a well-defined message. At this point in this example, the collective intent of the security semantics has already been expressed within the message, thus making the message a well-defined message. The intermediary device may receive the well-defined message from a sender device, which originated the message, or from another intermediary device. Flow proceeds to operation 304 where the intermediary device processes the security requirements of the well-defined message. In embodiments, processing the security requirements of the well-defined message may comprise analyzing and or viewing the well-defined message in order to determine the expressed collective intent of the well-defined messages security semantics. As previously noted, the expressed collective intent may restrict the intermediary device from performing certain actions (e.g., adding content or a signature to the message). In other embodiments, the expressed collective intent may require the intermediary device to perform a specific action upon the message. Flow proceeds to decision step 306 where the intermediary device determines whether it can fulfill the requirements of the well-defined message. If the intermediary device cannot fulfill the requirements, or if the intermediary device is unable to understand the requirements, flow branches NO to step 308 where the message is rejected. In embodiments, the message is discarded at step 308 rather than forwarding the message on to the recipient device in order to save bandwidth or processing resources due to the continued transmission of the message. This is due to the fact that, in embodiments of the present disclosure, a recipient device will reject a well-defined message whose security semantics have not been adhered to by intermediary devices, as will be discussed further with respect to FIG. 4.

If the intermediary device is able to understand and adhere to the expressed collective intent of the well-defined message, flow branches YES to step 310. Once the device has complied with the collective intent of security semantics in the well-defined message, the intermediary device transmits the well-defined message to either another intermediary device or to a recipient device. If the message is transmitted to another intermediary device, the method of FIG. 3 is again followed for the next intermediary device.

Upon receipt of the well-defined message by a recipient device, an embodiment of the method illustrated in the flow diagram of FIG. 4 may be employed. Flow begins at operation 402 where a recipient device receives a well-defined message. A recipient device is the intended recipient of the well-defined message. Upon receipt of the well-defined message, flow proceeds to step 404 where the recipient device processes the security requirements of the well-defined message. Because the security requirements of the well-defined message are clearly expressed, as described in FIGS. 1 and 2, the recipient device is able to process these requirements using fewer resources than are required to process a traditional message. For example, the recipient device need only understand the expressed collective intent of security semantics declared in the well-defined message. Upon determining the security requirements from the well-defined message, flow proceeds to decision step 406 where a decision is made as to whether the security requirements of the collective intent have been fulfilled. If the requirements have not been fulfilled, flow branches NO to operation 408 and the recipient device rejects the message. If the requirements have been fulfilled, flow branches YES to operation 410 where the recipient device accepts the message which may include processing and/or responding to the message.

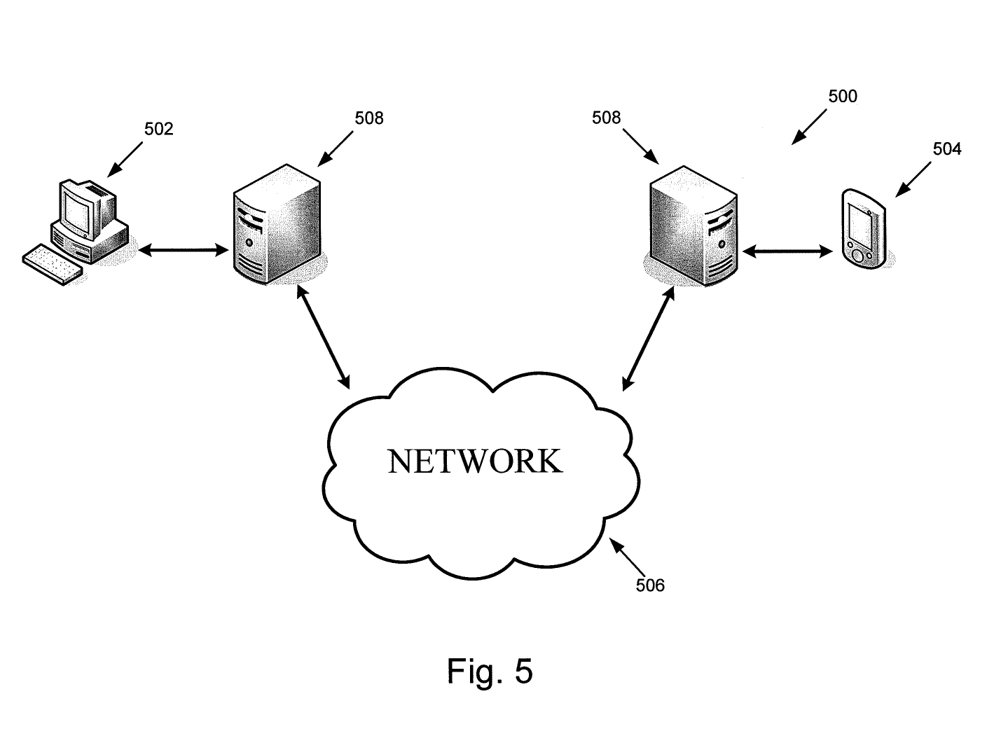

FIG. 5 is a functional diagram illustrating an embodiment of a system 500 for transmitting a message that expresses a collective intent of security semantics from a sender device 502 to a recipient device 504. In embodiments, sending device 502 may be a computing device such as a personal computer, a desktop computer, a laptop computer, a workstation, a server, etc. In further embodiments, sending device 502 may be a small computing device such as a PDA, a smart phone, a cell phone, etc. In embodiments, recipient device may be a small computing device such as a PDA, a smart phone, a cell phone, etc. In other embodiments, recipient device may be a personal computer, a desktop computer, a laptop computer, a workstation, a server, etc.

In embodiments, the sender device 502 generates a message. The message may be generated according to the method presented in FIG. 2. In embodiments, the message generated by sender device 502 may be a well-defined message. In such embodiments, the message may be transmitted from the sender device 502 to a recipient device 504. In one embodiment, the well-defined message may be transmitted via a direct connection between the sender device 502 and the recipient device 504 (not pictured). In other embodiments, the well-defined message may be transmitted from the sender device 502 to the recipient device 504 via a network 506. In embodiments, the network 506 may be the Internet. In other embodiments, the network 506 may be another type of network such as an intranet, an extranet, a local area network (“LAN”), a wide area network (“WAN”), a public switched telephone network, a cellular network, a wireless LAN, a wireless metropolitan area network (“MAN”), or any other type of network capable of transmitting messages between devices.

In embodiments, messages passed between the sender device 502 and the recipient device 504 may pass through and/or be processed by one or more intermediary devices 508. In embodiments, an intermediary device 508 may be a sever, a network server, a gateway server, a personal computer, a desktop computer, a laptop computer, a workstation, or any other type of computing device capable of receiving and transmitting messages. In embodiments where the one or more intermediate devices 508 receive a well-defined message, the intermediary device may process the message according to the method presented in FIG. 3. If the intermediary device 508 does not understand or is not able to adhere to the expressed collective intent, the well-defined message is discarded. If the intermediary device 508 is capable of understanding and adhering to the expressed collective intent of the well-defined message, the intermediary device 508 transmits the message forward to either another intermediary device 508 or a recipient device 504. Upon receipt of the well-defined message by the recipient device 504, the recipient device 504 may determine whether to accept or reject the well-defined message according the method described with respect to FIG. 4. In other embodiments, the recipient device may employ other methods known in the art to determine whether to accept or reject the well defined message.

In alternate embodiments, the sender device 502 may generate a message but not a well-defined message. In such embodiments, the message generated by the sender device 502 may be transmitted to one or more intermediary devices 508 en route to the recipient device 504. In such an embodiment, one of the one or more intermediary devices may modify the message by providing indications of security information within the message, as described with respect to FIG. 2. Once the indications of security messages are associated with the message, the message becomes a well-defined message, upon which time all other intermediary devices 508 who process the device must adhere to the expressed collective intent of security semantics within the well-defined message. From this embodiment, it becomes apparent that devices other than the sending device 502 may modify the message such that the message indicates an express intention of security semantics.

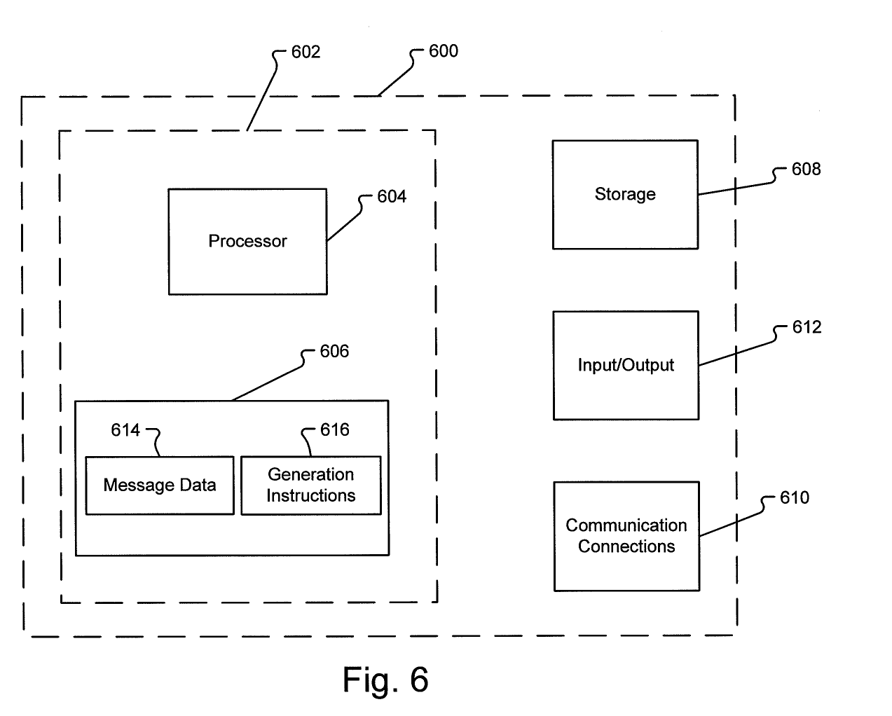

With reference to FIG. 6, an embodiment of a computing environment for implementing the various embodiments described herein includes a computer system, such as computer system 600. Any and all components of the described embodiments may execute as or on a client computer system, a server computer system, a combination of client and server computer systems, a handheld device, and other possible computing environments or systems described herein. As such, a basic computer system applicable to all these environments is described hereinafter.

In its most basic configuration, computer system 600 comprises at least one processing unit or processor 604 and system memory 606. The most basic configuration of the computer system 600 is illustrated in FIG. 8 by dashed line 602. In some embodiments, one or more components of the described system are loaded into system memory 606 and executed by the processing unit 604 from system memory 606. Depending on the exact configuration and type of computer system 600, system memory 606 may be volatile (such as RAM), non-volatile (such as ROM, flash memory, etc.), or some combination of the two.

Additionally, computer system 600 may also have additional features/functionality. For example, computer system 600 includes additional storage media 608, such as removable and/or non-removable storage, including, but not limited to, magnetic or optical disks or tape. In some embodiments, software or executable code and any data used for the described system is permanently stored in storage media 608. Storage media 608 includes volatile and non-volatile, removable and non-removable media implemented in any method or technology for storage of information such as computer readable instructions, data structures, program modules, or other data. In embodiments, mammogram images and/or results of probability determination are stored in storage media 608.

System memory 606 and storage media 608 are examples of computer storage media. Computer storage media includes, but is not limited to, RAM, ROM, EEPROM, flash memory or other memory technology, CD-ROM, digital versatile disks (“DVD”) or other optical storage, magnetic cassettes, magnetic tape, magnetic disk storage, other magnetic storage devices, or any other medium which is used to store the desired information and which is accessed by computer system 600 and processor 604. Any such computer storage media may be part of computer system 600. In some embodiments, mammogram images and/or results of probability determination are stored in system memory 606. In embodiments, system memory 606 and/or storage media 608 stores data used to perform the methods or form the system(s) disclosed herein, such as generating well-defined messages, expressing a collective intent of security semantics, accepting and/or rejecting well-defined messages, etc. In embodiments, system memory 606 would store information such as message data 614 and generation instructions 616. In embodiments, message data 614 may contain data used in generating a message, such as data related to: the message body, the security semantics of the message, the encryption algorithm used on the message, protocols used by the message, message signatures, etc. Generation instructions 616, in embodiments, store the instructions necessary to generate the messages and/or perform the disclosed methods and systems. For example, application data 616 may include functions or processes for generating a message, generating an expression of a collective intent of security semantics for a message, processing a message, etc.

Computer system 600 may also contain communications connection(s) 610 that allow the device to communicate with other devices. In embodiments, communications connection(s) 610 may be used to transmit and receive messages between sender devices, intermediary devices, and recipient devices. Communication connection(s) 610 is an example of communication media. Communication media may embody a modulated data signal, such as a carrier wave or other transport mechanism and includes any information delivery media, which may embody computer readable instructions, data structures, program modules, or other data in a modulated data signal. The term “modulated data signal” means a signal that has one or more of its characteristics set or changed in such a manner as to encode information or a message in the data signal. By way of example, and not limitation, communication media includes wired media such as a wired network or direct-wired connection, and wireless media such as an acoustic, RF, infrared, and other wireless media. In an embodiment, mammogram images and or determinations of probability results may be transmitted over communications connection(s) 610.

In some embodiments, computer system 600 also includes input and output connections 612, and interfaces and peripheral devices, such as a graphical user interface. Input device(s) are also referred to as user interface selection devices and include, but are not limited to, a keyboard, a mouse, a pen, a voice input device, a touch input device, etc. Output device(s) are also referred to as displays and include, but are not limited to, cathode ray tube displays, plasma screen displays, liquid crystal screen displays, speakers, printers, etc. These devices, either individually or in combination, connected to input and output connections 612 are used to display the information as described herein. All these devices are well known in the art and need not be discussed at length here.

In some embodiments, the component described herein comprise such modules or instructions executable by computer system 600 that may be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some embodiments, computer system 600 is part of a network that stores data in remote storage media for use by the computer system 600.

This disclosure described some embodiments of the present disclosure with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although the embodiments have been described in language specific to structural features, methodological acts, and computer-readable media containing such acts, it is to be understood that the possible embodiments, as defined in the appended claims, are not necessarily limited to the specific structure, acts, or media described. One skilled in the art will recognize other embodiments or improvements that are within the scope and spirit of the present disclosure. Therefore, the specific structure, acts, or media are disclosed only as illustrative embodiments. The disclosure is defined by the appended claims.

What is claimed is:

1. A computer storage medium encoding computer-readable instructions executable by a processor for performing a method of transmitting well-defined messages between devices, the method comprising:
generating a message, wherein the message comprises an expression of a collective intent of a self-contained block of security semantics, and wherein the message requires any device that receives the message to adhere to the collective intent expressed in the message or reject the message; and
sending the message.

2. The method of claim 1, wherein the expression of collective intent is included within a security header.

3. The method of claim 1, wherein the expression of the collective intent further comprises an intention to use a specific message protocol.

5. The method of claim 1, wherein the expression of the collective intent further comprises an indication of a specific algorithm suite for processing the message, wherein the algorithm suite may include a single algorithm.

6. The method of claim 1, wherein the expression of the collective intent further comprises an indication of a specific use of signatures to identify originators.

7. The method of claim 1, wherein the expression of the collective intent further comprises an intention to use a specific type of message encryption.

8. The method of claim 1, wherein the expression of the collective intent further comprises an intention to use a specific type of canonicalization.

9. A method of transmitting a well-defined message between devices, the method comprising:
generating a message, wherein the message comprises:
a next-hop security element that indicates security processing instructions, wherein the next-hop security element defines a type of canonicalization that must be adhered to by all intermediary devices that process the message;
an expression of a collective intent of a self-contained block of security semantics, wherein the message requires any device that receives the message to adhere to the collective intent expressed in the message or reject the message;
storing the message; and
sending the message.

10. The method of claim 9, wherein an enveloped signature is used with the next-hop security element to ensure that the type of canonicalization is applied to the portion of the message covered by the enveloped signature.

11. The method of claim 9, wherein the next-hop security element is a header of the message.

12. The method of claim 9, wherein the next-hop security element requires that intermediaries that do not understand or cannot conform to the security processing instructions must reject the message.

13. The method of claim 9, wherein the next-hop security element further comprises statements about signatures and the statements about the signatures must be adhered to by all intermediaries who process the message.

14. The method of claim 13, wherein the next-hop security element further defines the type of signatures used with the message.

15. The method of claim 9, wherein expressing the collective intent further comprises at least one of:
expressing an intention to use a specific message protocol;
indicating a specific algorithm suite for processing the message;
indicating a specific use of signatures to identify originators; and
indicating a specific type of required message encryption.

16. A system for transmitting a well-defined message between computing devices; the system comprising:
a sender device for generating a message, wherein generating a message comprises:
inserting a signed manifest element into the message, wherein the manifest element expresses the collective intent of a self-contained block of security semantics, inserting a next-hop header that defines a canonicalization, wherein the canonicalization must be adhered to by all intermediaries who process the message;
a first intermediary device for receiving the message from the sender, wherein the first intermediary device rejects the message if it cannot adhere to the collective intent and canonicalization; and
a recipient device for receiving the message from the first intermediary device, wherein the recipient device checks to ensure that the collective intent and the canonicalization have been adhered to by the first intermediary device, and if not, the recipient device rejects the message.

17. The system of claim 16, further comprising a second intermediary device, wherein the message is passed between from the first intermediary device to the second intermediary device unless the first intermediary device rejects the message.

18. The system of claim 17, wherein the first and second intermediary devices must adhere to the collective intent and the canonicalization.

19. The system of claim 16, wherein the first intermediary device may add information to the message so long as the information adheres to the collective intent and the canonicalization.

20. The system of claim 16, wherein the recipient device rejects the message if the manifest element is removed by the first intermediary device.
